(19) United States
(12) Patent Application Publication
(10) Pub. No.: US 2004/0133560 A1
(43) Pub. Date: Jul. 8, 2004

(54) Methods and systems for organizing electronic documents

(76) Inventor: Steven J. Simske, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 10/338,584

(22) Filed: Jan. 7, 2003

(51) Int. Cl. G06F 7/00

(52) U.S. Cl. 707/3

(57) ABSTRACT

A method for organizing electronic documents may include generating a list of weighted keywords for each document, clustering related documents together based on a comparison of the weighted keywords, and linking together portions of documents within a cluster based on a comparison of the weighted keywords.

### BACKGROUND

The invention of the computer, and subsequently, the ability to create electronic documents has provided users with a variety of capabilities. Modern computers enable users to electronically scan or create documents varying in size, subject matter, and format. These documents may be located on a personal computer, network, Internet, or other storage medium.

With the large number of electronic documents accessible on computers, particularly, through the use of networks and the Internet, grouping these documents enables users to more easily locate related documents or texts. For example, subject, date, and alphabetical order, may be used to categorize documents. Links, e.g., an Internet hyperlink, may be established between documents or texts which allow the user to go from one related document to another.

One method of organizing documents and linking them together is through the use of keywords. Ideally, keywords reflect the subject matter of each document, and may be chosen manually or electronically by counting the number of times selected words appear in a document and choosing those which occur most frequently or a minimum number of times. Other methods of generating keywords may include calculating the ratio of word frequencies within a document to word frequencies within a designated group of documents, called a corpus, or choosing words from the title of a document.

These methods, however, offer only incomplete solutions to keyword selection because they focus only on the raw number of occurrences of keywords, or words used in a title, neither of which may accurately reflect the document's subject matter. As a result, documents organized using keywords generated as described above may not provide accurate document organization.

### BRIEF DESCRIPTION OF THE DRAWINGS

The accompanying drawings illustrate various embodiments of the present invention and are a part of the specification. The illustrated embodiments are examples of the present invention and do not limit the scope of the invention.

FIG. 1 is a flowchart illustrating a method of selecting keywords according to an embodiment of the present invention.

FIG. 2 is a flowchart illustrating a method of weighting non-numeric attributes according to an embodiment of the present invention.

FIG. 3 illustrates an example of computer code used in an embodiment of the invention.

FIG. 4 is a representative diagram of keywords and weightings generated by an embodiment of the invention.

FIG. 5 is a block diagram illustrating a method of clustering similar documents using keyword weights according to an embodiment of the present invention.

FIG. 6 is a block diagram illustrating a method of creating document summaries according to an embodiment of the present invention.

FIG. 7 is a block diagram illustrating a relevancy metric calculation process according to an embodiment of the present invention.

FIG. 8 is a diagram of a system according to embodiment of the present invention.

Throughout the drawings, identical reference numbers designate similar, but not necessarily identical, elements.

### DETAILED DESCRIPTION

Representative embodiments of the present invention provide, among other things, a method and system for organizing electronic documents by generating a list of weighted keywords, clustering documents sharing one or more keywords, and linking documents within a cluster by using similar keywords, sentences, paragraphs, etc., as links. The embodiments provide customizable user control of keyword quantities, cluster selectivity, and link specificity, i.e., links may connect similar paragraphs, sentences, individual words, etc.

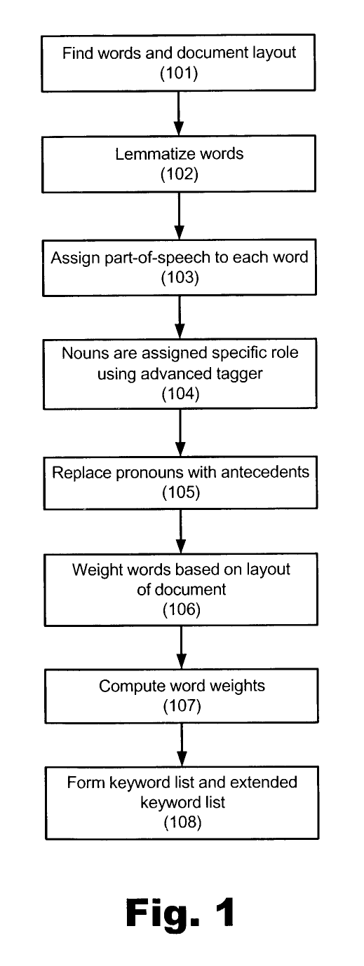

FIG. 1 is a block diagram illustrating a method of generating a list of weighted keywords according to an embodiment of the present invention. For each document being considered, all definable, or recognizable, words, numbers, etc., as determined by standard state-of-the-art software, are identified (step 101). If any documents being considered are paper-based, tools such as a zoning analysis engine in combination with an optical character recognition (OCR) engine may be used to convert the paper-based document to an electronic document. Additionally, the zoning analysis and OCR tools may automatically differentiate between words, non-words, and numbers and provide information on the layout of the document.

If the document is originally electronic or the zoning analysis and OCR tools do not prepare the document adequately, other software tools may be used to prepare the document for keyword analysis, i.e., software tools are needed to separate words and non-words and record document layout information. The words and all other information related to each word are stored in arrays generated by software.

Once all recognizable words are found, lemmatization (replacing each word with its root form) takes place (step 102) and a Parts-of-Speech (POS) tagger (software that designates each word or lemmatized word as a noun, verb, adjective, adverb, etc.) assigns each word a grammatical role (step 103). In some embodiments, only nouns and cardinal numbers are used as possible keywords.

Using an advanced POS tagger, nouns are categorized (step 104) by grammatical role (proper noun vs. common noun vs. pronoun, and singular vs. plural), and noun role (subject, object, or other). All antecedents of the pronouns in the document are then identified and used to replace (step 105) all the pronouns in the document. For example, the sentences, “John saw the ball coming. He caught it and threw it to Paul,” contain the word “ball” once and “John” once. If each pronoun is replaced with the equivalent antecedent (step 105), the sentences would read, “John saw the ball coming. John caught ball and threw ball to Paul,” changing the word count of “John” to two, and “ball” to three.

The last step in preparing the document for keyword weight calculation is to weight words based on the layout of the document (step 106). Using position and font information, e.g., title, boldface, footer, normal text, etc., words may be assigned a “layout role weight.”

There are many different methods by which words in a document may be assigned a layout role weight. For example, any categorizing or sub-categorizing tool, e.g., pages, files, folders, etc., may be used to catalog words in a document based on document layout. Alternatively, separating words into different layout categories need not occur as long as each word is assigned a layout role weight.

Additionally, there exist many different document layouts. For example, some document layouts may include only text and pages, while other documents layouts may include, title, text, columns, boldface text, italic text, colored text, tables, footnotes, bibliography, etc. Therefore, a variety of layout weight assignments and methods of organizing document text for the purpose of assigning a layout role weight exist.

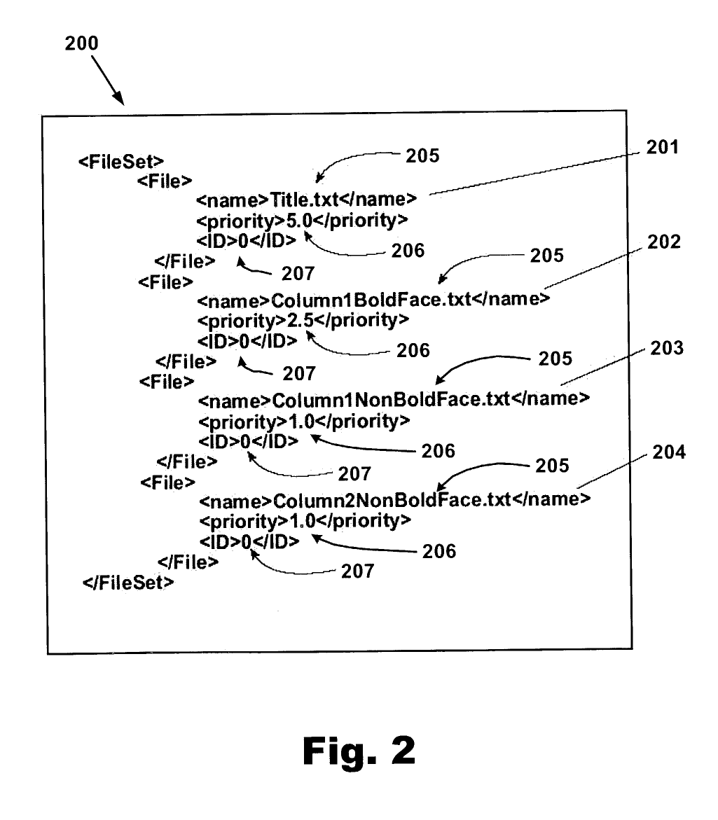

While other possibilities exist as explained above, in one embodiment, electronic files are used to hold words for each layout category. FIG. 2 is an example of code that may be used to organize and define word weight based on layout role. More specifically, FIG. 2 is an XML (markup language) definition (200) of a document containing four different categories of text. The document represented may have been an article composed of a title, two columns of text, and a sentence printed in boldface.

As shown in FIG. 2, the title (201), the boldfaced portion of the first column (202), the non-boldfaced (203) portions of the first column, and the second column (204) are each given a filename (205) and a weight (206). This particular XML schema weights the title 5 times as much as normal text and boldfaced text 2.5 times as much as normal text. The same <ID> number (207) is used for all of the files in this example, indicating that each file is a component of the same document.

While XML is used in an embodiment of the invention, any other manifestation vehicle, i.e., any other means of representing the weighting and layout of a document, is allowable. For example, databases, file systems, and structures or classes in a programming language such a “C” or “Java” can provide the same organization as XML. Markup languages, i.e., a computer language used to identify the structure of a document, such as XML or SGML (Standard Generalized Markup Language), are preferred because they provide readability, portability, and conform to present standards.

In the XML embodiment described above, the invention divides a document into files determined by the layout of the document. All word lemmas, grammatical roles, noun roles, etc., are internal to these files, optimizing the performance (speed) of the method. Alternatively, documents may be divided in other ways or not at all when determining layout roles, grammatical roles, etc.

Once weights are assigned to words based on the document layout (step 106), an overall weight is calculated for each word (step 107). While other words (verbs, adjective, adverbs, etc.) may be used as keywords in embodiments of the invention, practical implementations may restrict keywords to nouns and cardinal numbers. Using only nouns and cardinal numbers as keyword possibilities provides highly descriptive keyword lists, while simplifying the overall keyword selection process by reducing the number of possible choices.

Word weight may be computed (step 107), among other methods, by counting the number of times that word (including pronouns of that word) occurs in the document to produce a word count. By multiplying the word count by a “mean role weight” and a square root of the word's lemma length, which are used to estimate the word's importance, a total word weight is calculated. The “mean role weight” is determined by summing the average grammatical role weight, noun role weight, and layout role weight of a word. In the exemplary embodiment, the overall weight of each keyword is calculated (step 107) as shown in the following equation:

Weight=(GRoleWeighti×NRoleWeighti×LayoutWeighti)×sqrt(length) (1)

where, “i” designates a particular occurrence of a term, “N” is the number of times (including pronouns and deictic pronouns) the term has occurred in the document, “length” is the length of the term's lemma (or lemma length), “GRoleWeight” is a grammatical role weight, “NRoleWeight” is a noun role weight, and “LayoutWeight” is a layout role weight as explained below.

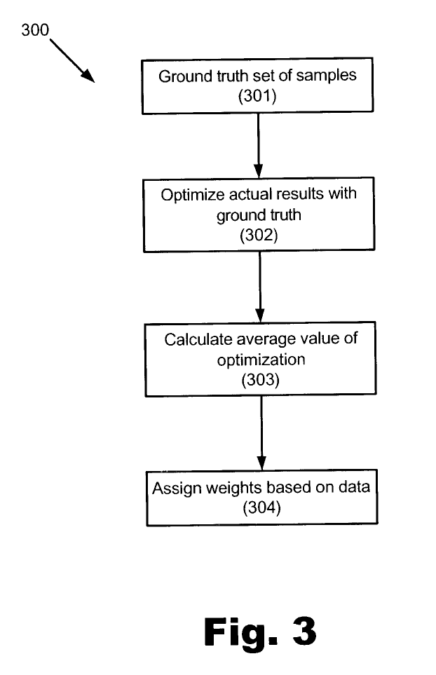

There are several different weights that could be assigned to GRoleWeight, NRoleWeight, and LayoutWeight. For example, in one embodiment, GRoleWeight may be one of five weights, depending on the grammatical role of a term. Specifically, the possible grammatical roles (attributes) for GRoleWeight are: cardinal number, common noun-singular, common noun-plural, proper nouns, and personal pronouns. Each attribute is assigned a weight according to the method (300) shown in FIG. 3.

In order to weight non-numeric attributes, such as the grammatical role of words in a document, a “ground truth” is first created (step 301). The ground truth is a set of manually ranked samples that provide a means of testing experimental weight values for non-numeric attributes. As implemented in an embodiment of the invention, an appropriate ground truth is a set of documents with manually ranked keywords. In order to be effective, the set of samples used for the ground truth should be statistically large enough to ensure non-biased results.

After a ground truth (step 301) has been established, one sample from the ground truth set is chosen for experimentation, e.g., one document with manually chosen keywords. The experiment consists of varying the weighting, e.g., ranging the weight from 0.1 to 10.0 using 0.1 steps, for a particular attribute (while all other attributes are held constant to 1.0) until a value that correlates actual results with the ground truth sample is found (step 302). By performing the same experiment on a set of samples from the ground truth (step 301), an average value of correlation can be calculated (step 303) for each attribute. Once all data has been collected, weights for different attributes are assigned (step 304) corresponding to the correlation experiments.

For example, when determining a weight for a GRoleWeight attribute, such as “proper noun,” an appropriate ground truth (step 301) would be a set of documents with keywords provided by the authors. By choosing one document from the ground truth, weighting the proper noun attribute from 0.1 to 10.0 using 0.1 steps, and maintaining all other attribute weights constant at 1.0, the list of keywords generated by the host device varies from the keywords provided by the author of the chosen document. The proper noun weight value that best generates the same keywords (additionally, the relative ranking order of the keywords, e.g., 1^{st}, 2^{nd}, 3^{rd}, etc., may also be used) as provided in the ground truth (step 302) sample is selected for each document.

If the correlating proper noun weights for a ground truth of five sample documents were found to be, for example, 1.2, 1.5, 1.6, 1.7, and 2.5, the average value of correlation (step 303) is 1.7. The average value of correlation (1.7 in this case) is then assigned (step 304) as the proper noun weight. Using this method (300) on a larger ground truth (24 documents), the following grammatical role weights were assigned in one example:

TABLE 1
(Grammatical Role Weights)

| Grammatical Role | GRoleWeight |
|---|---|
| Cardinal Number | 1.0 |
| Common Noun-Singular | 1.01 |
| Common Noun-Plural | 1.0 |
| Proper Noun | 1.5 |
| Personal Pronoun | 0.1 |

Using a similar method (300), attribute weights for NRoleWeight, a weight based on how a noun is used, and LayoutWeight, a weight based on document layout as explained above, were calculated and assigned in this example as follows:

TABLE 2
(Noun Role Weights)

| Noun Role | NRoleWeight |
|---|---|
| Subject | 1.25 |
| Object | 1.0 |
| Other | 1.05 |

TABLE 3
(Document Layout Weights)

| Layout Role | LayoutWeight |
|---|---|
| Normal text | 1.0 |
| Table and Figure headings | 1.25 |
| Italic text | 1.5 |
| Bold text | 2.5 |
| Title | 5.0 |

While the weight values of Tables 1, 2, and 3, are used in one embodiment, it is intended that all attribute weights be customizable to the needs of each user. For example, different document corpuses and writing genres may require adjustment to the values for GRoleWeight, NRoleWeight, and LayoutWeight in order to optimize the generation of keywords. The weighting adjustment may be done in a variety of ways, including, using a new ground truth (reflecting the document corpus to be organized) according to the method (300) described in FIG. 3, trial and error, or any other method which generates functional attribute weights. Assuming all attributes are independent of each other, the weight of each attribute plays a significant part in generating the keyword list.

After a set of attribute weights (in conjunction with the total keyword weight equation shown above) are found to effectively produce keywords correlated with ground truth samples, the same attribute weights and total keyword weight equation may be implemented to produce (with a high probability of success) accurate keywords for any document with similar writing genre.

In this example, using a computer program which implements the total keyword weight equation and the set of attribute weights for GRoleWeight, NRoleWeight, and LayoutWeight shown above, may be used to provide an automated means for generating accurate keywords for electronic documents. By calculating an overall weight (step 107, FIG. 1), according to equation (1), for all recognizable terms in a document, a keyword list and “extended keyword list”, i.e., keywords including surrounding text, may be formed (step 108) using the most highly weighted terms in a document.

The extended keyword list may contain phrases as well as individual keywords that are identified by the word “taggers”, i.e., computers programs which identify words, words groups, phrases, etc. Using the extended keywords to compare documents may help account for words groups, e.g., New York City, in the documents that are significant but would not be identified correctly without including the surrounding text. Extended word lists are commonly needed for identifying proper nouns and noun phrases.

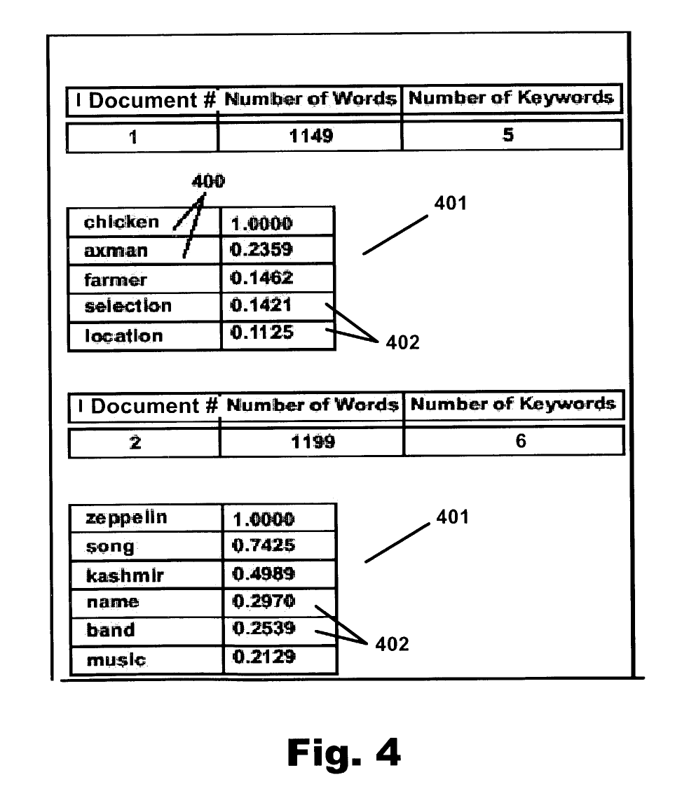

In the keyword generation example shown in FIG. 4, a minimum of five keywords (400) make up a keyword list (401) for each of two documents. In this example, additional keywords (other than the five minimum) are included in a keyword list (401) if their weights (402) are at least 20% of the most highly weighted word weight. For example, if the highest keyword weight is 1.0, only words with a total weight greater than 0.2 would be included in the keyword list. Again, the user may customize the number of keywords in the weighted keyword list to meet individual needs. This may be done by designating a fixed number of keywords to be generated, including only keywords whose weights are above a certain percentage, e.g., 10%, 20%, etc., of the highest keyword weight, or any other method of setting boundaries for the keyword list.

Each weighted keyword list generated for one or more documents may be used in a variety of ways. One use of the keyword list within the scope of the invention is in conjunction with a document summarizer.

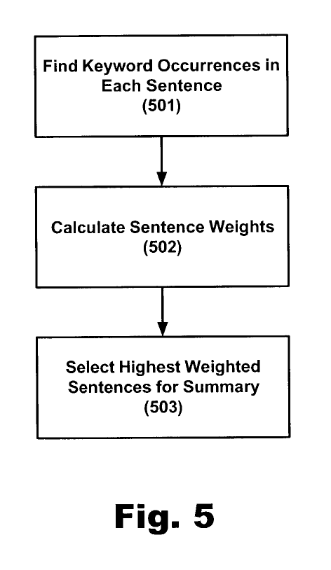

Using normalized keyword weights, i.e., keyword weights divided by the highest keyword weight, a document summary may be created by the process illustrated in FIG. 5 and discussed with reference to Table 4 below:

TABLE 4

| | #A | #B | #C | | | |
|---|---|---|---|---|---|---|
| Sentence | (1.0) | (0.6) | (0.5) | #D (0.3) | #E (0.2) | SentenceWeight |
| S1 | 1 | 0 | 1 | 0 | 0 | 1.0 + 0.5 = 1.5 |
| S2 | 0 | 2 | 0 | 0 | 0 | 0.6 + 0.6 = 1.2 |
| S3 | 1 | 1 | 0 | 1 | 1 | 1.0 + 0.6 + |
| | | | | | | 0.3 + 0.2 = 2.1 |
| S4 | 0 | 0 | 1 | 0 | 0 | 0.5 = 0.5 |

Table 4 illustrates a document paragraph having four sentences S1, S2, S3, and S4. The document in this example has been examined and five keywords, A, B, C, D, and E, have been generated. As shown in parenthesis in Table 4, the normalized weights for keywords A, B, C, D, and E are 1.0, 0.6, 0.5, 0.3, and 0.2, respectively.

To summarize a document according to the method shown in FIG. 5, the host device searches every sentence for words in the keyword list (501). Once the keywords are located, a sentence weight is calculated (502), for example, by adding together all the keyword weights (including multiple occurrences of the same keyword) for each sentence. As shown in Table 4, each sentence S1 through S4 has a corresponding sentence weight, with sentence S3 having the highest weight. Those sentences having the highest weight, e.g., S3 in Table 4, would then be selected as part of the document summary (503).

By using the techniques described by FIG. 5, a document summarizer, implemented with a computer program, is capable of creating summaries of various lengths, i.e., the length is determined by the number of sentences in the summary. The sentences included in the summary can be configured to include only the highest weighted sentence from every paragraph, multiple paragraphs, one or more pages, etc. Another possible variation includes ranking all of the sentences in a document by weight and then selecting a quantity, e.g., integer number, percentage of document, etc., of highest ranked sentences for the summary. By using these or other summary configurations, a user may control the length of the summary before the summary is actually generated.

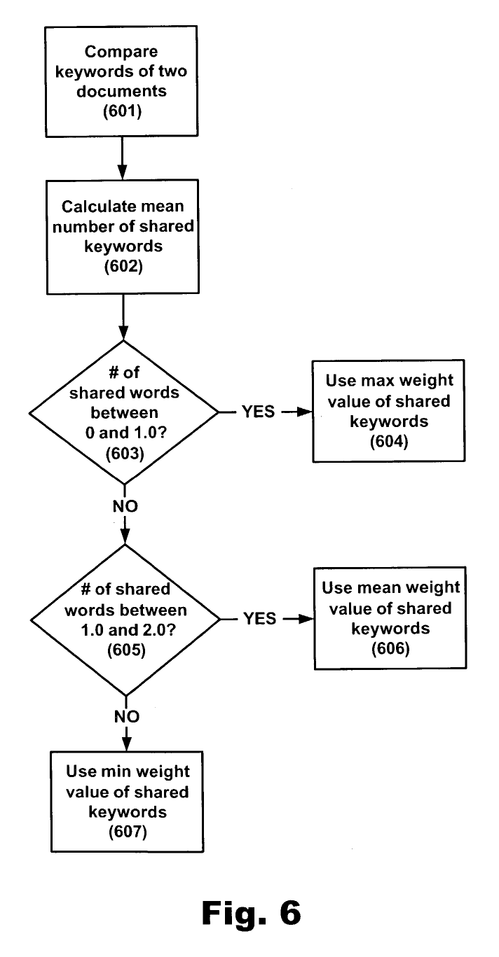

Once a summary is created, it can be used as a “quick-read” of a larger article or in a condensed document clustering method. The same method used to cluster documents may be used for summaries as well with the benefit of optimizing the performance of the invention. The process, described in FIG. 6, clusters documents that share one or more keywords by calculating and applying a “shared word weight.” The clustering of documents and summaries may occur independently or in conjunction with each other.

As shown in FIG. 6, the clustering process begins when the weighted keyword lists of two or more documents are compared (step 601). The host device calculates a value, called “shared word weight,” that correlates the two documents. The shared word weight value indicates the extent to which two or more documents are related based on their keywords. A higher shared word weight indicates that the documents are more likely to be related.

In the embodiment illustrated by Table 5, each keyword list is normalized to have a total weight of 1.0. Normalization provides a keyword weighting scheme in which many documents' keywords can be compared as to their relative importance.

TABLE 5

| Document 1 | Document 2 |
|---|---|
| Hockey, 0.4 | Skating, 0.3 |
| Skating, 0.25 | Rollerblading, 0.3 |
| Pond, 0.2 | Inline, 0.2 |
| Rink, 0.1 | Goalie, 0.15 |
| Puck, 0.05 | Hockey, 0.05 |

As shown in Table 5, the documents share two keywords, “Hockey” and “Skating.” The shared word weight value of the keywords may be chosen in a variety of ways, e.g., maximum, mean, and minimum.

If the maximum shared word weight value is chosen, the two documents have a “0.7” shared word weight, i.e., the maximum weight for a shared keyword in document 1 is “Hockey, 0.4,” and the maximum weight for a shared keyword in document 2 is “Skating, 0.3.” Adding these two maximum shared values together gives the “0.7” shared word weight.

If the mean shared word weight value is chosen, the two documents have a “0.5” shared word weighting, i.e., the sum of all weight values for “Hockey” and “Skating” is 0.4+0.25+0.3+0.05=1.0. Since there are two documents the mean shared word weight value is 1.0/2=0.5.

If the minimum shared word weight value is chosen, the two documents have a “0.3” shared word weighting, i.e., the minimum weight for a shared keyword in document 1 is “Skating, 0.25,” and the minimum weight for a shared keyword in document 2 is “Hockey, 0.05.” Adding these two minimum shared values together gives the “0.3” shared word weight.

The maximum, mean, and minimum shared word weight values may be used by an embodiment of the invention to determine which documents to include in a cluster, and which documents to exclude. More specifically, in a preferred embodiment, a threshold shared word weight value is chosen for inclusion in a cluster. For example, if a threshold shared word weight value of 0.7 is designated, and the two documents of Table 5 are being compared for possible clustering, using the maximum shared word weight value (1.0) will cluster the two documents, while using the mean shared word weight (0.5) or minimum shared word weight values (0.3) will not cluster the two documents. The same process may be used for large document corpuses to produce clusters of related documents.

While there exist a variety of methods that may be used to cluster documents, such as clustering documents with common titles, using weighted keywords to determine similarities between documents, etc., a preferred method uses a threshold shared word weight and a maximum, mean, or minimum shared word weight as explained above.

More specifically, the determination of whether to utilize the maximum, mean, or minimum shared word weight value (as shown in FIG. 6) is made by calculating and then inspecting the average number of shared keywords (step 602) within a document corpus, i.e., the keyword lists of many documents (not just two) may be compared and analyzed at the same time. If the average number of shared words is between 0 and 1.0 (determination 603), the maximum shared word weight is used for clustering (step 604). If the average number of shared words is between 1.0 and 2.0 (determination 605), the mean shared word weight is used for clustering (step 606). If the average number of shared words is neither between 0 and 1.0 nor between 1.0 and 2.0 (determinations 603, 605), i.e., if the mean number of shared keywords is greater than 2.0, the minimum shared word weight is used for clustering (step 607). By using the minimum shared word weight for clustering documents sharing two or more keywords, documents that are only marginally-related are less likely to be clustered.

For the example of the two documents of Table 5, the average number of shared words is 2.0, because each document contains two keywords, “hockey” and “skating”, in common with the other document. Therefore, the mean shared word weight value (0.5) would be used in the illustrated embodiment to determine if the documents should be clustered.

The documents included in each cluster may be adjusted by changing the threshold of the required shared word weight for clustering, changing the number of keywords included in each keyword list, or any other method of adjusting the clustering of documents, e.g., clustering in groups of five, ten, twenty, etc.

After clustering, “soft links” (links invisible to the user and automatically adjustable by the host device) can be created within documents to allow a user to move from one document section to another related section within the cluster. Using relevancy metrics (a calculation of text unit similarity using weighted keywords or other parameters), soft links can associate documents at an adaptable level of detail, i.e., soft links may connect similar words, sentences, paragraphs, pages, etc.

One method of calculating relevancy metrics would be summing the keyword weights (related to a specific word, phrase, or desired topic) found within a text unit, e.g., sentence, paragraph, or page. The text units with the highest weights related to the desired topic would be used for interlinking documents within a cluster.

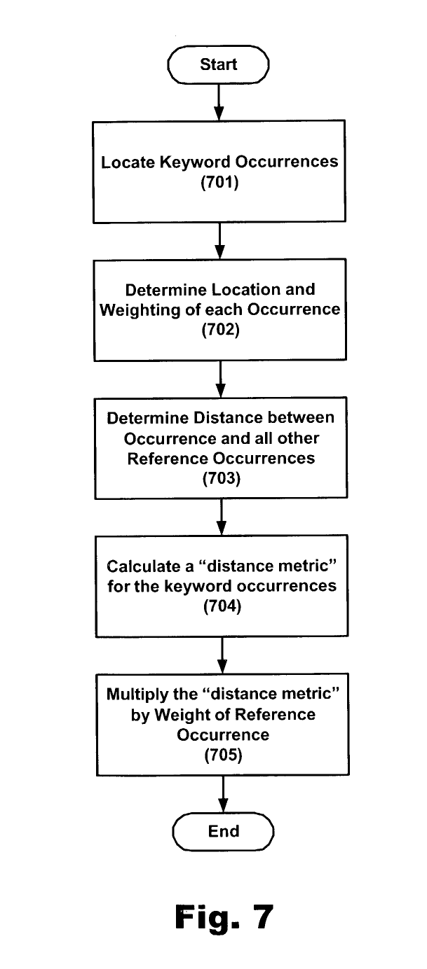

Another example of how a relevancy metric can be calculated based on keywords is shown in FIG. 7. Suppose a given page has four text units, e.g., sentence, paragraph, etc., containing a desired word, i.e., a word or topic the user would like to explore. The four occurrences of the desired word are located (step 701) and for convenience labeled A, B, C, and D. If A, B, C, and D, are located at character locations (as defined by counting the number of characters in a document from beginning to end) 100, 200, 300 and 1000, respectively, and the weightings of A, B, C and D are 1.5, 1, 1, and 1.5, respectively (step 702), relevance weightings for A, B, C, and D may be calculated as demonstrated in the following illustration:

for A, the weighting is=1.5×((1/100)+(1/200)+(1.5/900))=0.025;

for B, the weighting is=1×((1.5/100)+(1/100)+(1.5/800))=0.026875;

for C, the weighting is=1×((1.5/200)+(1/100)+(1.5/700))=0.019643; and

for D, the weighting is 1.5×((1.5/900)+(1/800)+(1/900))=0.006042.

For example, the relevance weight for A is calculated, as shown, by summing (step 704), the weight of B divided by the distance of B (as measured in characters) from A (step 703), the weight of C divided by the distance of C from A (step 703), the weight of D divided by the distance of D from A (step 703), then multiplying that sum by the weight of A (step 705). The summation of keyword weights divided by their respective distances to a particular occurrence can be called a “distance metric” (step 704).

The most highly-weighted relevancy terms are then soft-linked together. For this example, occurrence B has the highest relevancy and would be used for soft-linking to other related text units found in the same document or other documents. By linking to the B keyword occurrence (which is relatively close to A and C) rather than D, a user is more likely to find material related to the desired topic because the concentration of keywords (as calculated with a relevancy weight as explained above) is highest at location B.

Another possible way of weighting the relevancy metrics is to multiply the mean shared weight of extended words shared by two selected text units, e.g., sentences, by the frequency metric of the shared extended words, i.e., the mean ratio of the extended word occurrences in the two documents compared to their occurrences in the larger corpus.

Using relevancy metrics the invention attempts to link related documents in the most appropriate places. While soft links are only created within clustered documents in the present embodiment (to optimize performance), links can be created between any documents within a corpus or group of corpuses. Soft links may easily be changed into more permanent links, e.g., internet hyperlinks, to facilitate document organization and navigation on internet sites or other document sources. Soft links may also be automatically updated when additional documents are added to a document corpus.

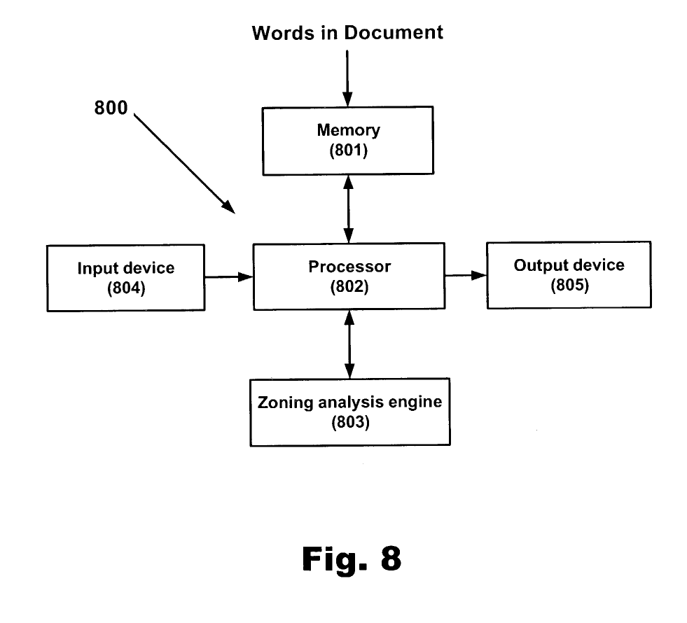

FIG. 8 is a block diagram illustrating one embodiment of a system that incorporates principles of the present invention. The system (800) includes a memory (801), a processor (802), an input device (804), a zoning analysis engine (803), and an output device (805). Using system (800) of FIG. 8 and computer readable instructions encoding the methods disclosed above, very efficient document organization may be performed. Through the input device (804), the user may customize the methods used for generating keywords, creating summaries, clustering documents, and linking.

The preceding description has been presented for illustrative purposes. It is not intended to be exhaustive or to limit the invention to any precise form disclosed. Many modifications and variations are possible in light of the above teaching. It is intended that the scope of the invention be defined by the following claims.

What is claimed is:

1. A method for organizing electronic documents, said method comprising:
generating a list of weighted keywords for one or more documents;
clustering related documents together based on a comparison of said weighted keywords; and
linking together portions of documents within a cluster based on a comparison of said weighted keywords.

2. The method of claim 1, wherein said clustering and said linking of documents are conducted automatically without user input.

3. The method of claim 1, wherein said generating a list of weighted keywords for each document, further comprises conducting zoning analysis on each document to identify a layout of each document.

4. The method of claim 3, wherein said generating a list of weighted keywords for each document further comprises dividing each document into a plurality of files, each file corresponding to a portion of the document as identified by the zoning analysis.

5. A method for generating keywords for a document, said method comprising:
identifying a plurality of words in the document;
identifying a role of each word;
computing a word weight for each word based on the role and position of the word in said document; and
selecting a number of keywords based on computed word weights.

6. The method of claim 5, wherein said identifying a plurality of words in the document comprises analyzing an electronic document and identifying all definable words and numbers.

7. The method of claim 5, wherein said identifying a role of each word, comprises:
lemmatizing the word; and
labeling each word with a corresponding part of speech.

8. The method of claim 7, wherein said labeling each word with a corresponding part of speech, comprises:
identifying an antecedent noun corresponding to each pronoun; and
replacing all pronouns with the corresponding antecedent noun.

9. The method of claim 7, wherein said labeling each word with a corresponding part of speech, further comprises:
identifying and labeling proper nouns;
identifying and labeling common nouns;
distinguishing and labeling singular and plural common nouns; and
identifying and labeling cardinal numbers.

10. The method of claim 7, wherein said labeling each word with a corresponding part of speech, further comprises:
identifying and labeling nouns as subjects of a sentence;
identifying and labeling nouns as objects of a sentence; and
identifying and labeling nouns as other nouns (not subjects or objects) in a sentence.

11. The method of claim 5, wherein said computing a word weight for each word comprises:
counting a number of times that word occurs in the document to produce a word count; and
multiplying said word count by a “mean role weight” and a square root of a lemma length.

12. The method of claim 11, wherein said “mean role weight” is found by summing an average grammatical role weight, noun role weight, and layout role weight of a word.

13. The method of claim 12, wherein said grammatical role weights, noun role weights, and layout role weights are assigned using a method for determining non-numerical attribute weights.

14. The method of claim 5, wherein said selecting a number of keywords based on word weights, comprises:
ranking the words by their associated word weights; and
selecting a number of words based on word weight to form a keyword list.

15. The method of claim 5, wherein said selecting a number of keywords based on word weight, further comprises generating an extended word set based on selected keywords.

16. A method of generating a summary for documents using weighted keywords from a document keyword list, each keyword having a word weight, said method comprising:
counting a number of keyword occurrences in each sentence;
computing a sentence weight for each sentence based on said number of keyword occurences; and
generating a summary for a document containing one or more of sentences from said document that are selected based on said sentence weights.

17. The method of claim 16, wherein said computing a sentence weight for each sentence comprises summing all said word weights of words in the keyword list found within each sentence.

18. The method of claim 16, wherein said generating a summary containing one or more sentences, comprises:
dividing the sentences into sentence groups; and
including at least one sentence from each sentence group in the summary.

19. The method of claim 18, wherein said sentence groups are paragraphs.

20. The method of claim 16, wherein said generating a summary containing one or more sentences comprises pre-selecting a summary length and including a number of sentences in said summary according to said pre-selected summary length.

21. A method for clustering a plurality of documents, each document having an associated keyword list containing keywords, each keyword having an associated word weight, said method comprising:
locating at least one keyword shared by at least two documents of said plurality of documents;
calculating a shared word weight; and
clustering documents with a shared word weight above a specified threshold.

22. A method for associating at least two text units, each text unit containing one or more weighted keywords, said method comprising:
defining a plurality of text units to compose a corpus of text units;
calculating a text unit relevancy metric for each text unit based on a comparison of said weighted keywords; and
selectively linking text units based on said text unit relevancy metrics.

23. The method of claim 22, wherein said text unit may be a word, phrase, sentence, paragraph, page, or document.

24. The method of claim 22, wherein said selectively linking text units, comprises creating an adaptable link between at least two text units based on said relevancy metrics.

25. The method of claim 24, wherein said adaptable link may be visible or invisible to a user.

26. The method of claim 25, wherein said adaptable link is an Internet hyperlink.

27. A program stored on a medium for storing computer-readable instructions, said program, when executed, causing a host device to:
analyze one or more documents;
generate a list of weighted keywords for each document;
cluster related documents together based on said weighted keywords; and
link together portions of clustered documents based on occurrences of said weighted keywords.

28. The program of claim 27, said program further causing said host device to conduct a zoning analysis on each document to identify the layout of said each document.

29. The program of claim 27, said program further casing said host device to:
recognize a plurality of words in a document;
identify a grammatical role of each recognized word;
compute a word weight for each word based on the grammatical role and position of the word in said document; and
select a number of words as keywords based on the word weights.

30. The program of claim 27, said program further causing the host device to:
lemmatize the words in a document; and
label each word with a corresponding part of speech.

31. The program of claim 27, said program further causing the host device to:
identify an antecedent noun corresponding to each pronoun in a document; and
replace all pronouns with the corresponding antecedent noun.

32. The program of claim 27, said program further causing the host device to calculate a word weight for every term in a document by:
counting a number of times a term occurs in a document; and
multiplying said number of times a term occurs by a “mean role weight” and a square root of a lemma length of that term.

33. The program of claim 27, said program further causing the host device to calculate a “mean role weight” by summing an average grammatical role weight, noun role weight, and layout role weight of a term.

34. The program of claim 27, said program further causing the host device to calculate grammatical role weights, noun role weights, and layout role weights using a method for weighting non-numerical attributes.

35. The program of claim 27, said program further causing the host device to normalize the words of the keyword list by dividing the word weights in the said keyword list by a highest word weight in the keyword list.

36. The program of claim 27, said program further causing the host device to normalize the words in the keyword list by dividing the word weights in the keyword list by a sum of all word weights in the keyword list.

37. The program of claim 27, said program further causing the host device to generate an extended word set containing selected keywords or selected keywords surrounded by words and phrases.

38. A program stored on a medium for storing computer-readable instructions, said program, when executed, causing a host device to:
count a number of keyword occurrences in each sentence of a document;
compute a sentence weight for each of sentence; and
generate a summary for the document containing one or more sentences from said document based on said sentence weights.

39. The program of claim 38, said program further causing the host device to define a sentence grouping, according to user input, and include at least one sentence in the summary from each sentence group in the sentence grouping.

40. The program of claim 38, said program further causing the host device to create a summary based on a pre-selected user-defined summary length.

41. The program of claim 38, said program further causing the host device to:
locate at least one weighted keyword that is shared among multiple documents or summaries;
calculate a shared word weight; and
cluster documents or summaries with a shared word weight above a specified threshold.

42. The program of claim 38, said program further causing the host device to select a maximum, mean, or minimum shared word weight for clustering based on an average number of keywords shared by the documents or summaries.

43. The program of claim 38, said program further causing the host device to:
define a plurality of text units in a corpus of text units;
calculate a text unit relevancy metric for each text unit based on a comparison of weighted keywords; and
selectively link text units based on the relevancy metrics.

44. The program of claim 38, said program further causing the host device to:
determine a location and a weight of keyword or extended keyword occurrences within a text unit;
calculate a text unit weight based on keyword weights; and
compute a relevancy metric for each text unit by multiplying a weight of a chosen text unit by a sum of other text unit weights divided by respective distances from said chosen text unit.

45. The program of claim 38, said program further causing the host device to create an adaptable link between at least two text units based on relevancy metrics.

46. The program of claim 38, said program further causing the host device to automatically readjust links when new text units are added to the corpus of text units.

47. A system for organizing electronic documents, said system comprising:
means for generating a list of weighted keywords for each document;
means for clustering related documents together based on said weighted keywords; and
means for linking together corresponding portions of said documents within a cluster based on said weighted keywords.

48. The system of claim 47, further comprising means for conducting zoning analysis on each document to identify a layout of the document.

49. The system of claim 47, further comprising means for:
obtaining a plurality of words in a document;
identifying a role of each word;
computing a word weight for each word based on a role and position of the word; and
selecting a number of keywords based on the word weights.

50. The system of claim 47, further comprising means for analyzing electronic documents and identifying all recognizable words and numbers.

51. The system of claim 47, further comprising means for:
lemmatizing words; and
labeling each word in a document with a corresponding part of speech.

52. The system of claim 47, further comprising means for counting the number of times a term occurs in a document and multiplying a term count by a “mean role weight” and a square root of a lemma length for that term.

53. The system of claim 47, further comprising means for summing an average grammatical role weight, noun role weight, and layout role weight of a term.

54. The system of claim 47, further comprising means for generating an extended word set containing keywords or keywords surrounded by words and phrases that may supplement a meaning and use of said keywords.

55. The system of claim 47, further comprising means for:
counting a number of keyword occurrences in a sentence;
computing a sentence weight for a sentence based on keyword occurrences; and
generating a summary for a document containing one or more sentences from said document based on sentence weights.

56. The system of claim 47, further comprising means for allowing a user to pre-select a summary length.

57. The system of claim 47, further comprising means for:
locating at least one keyword shared by a plurality of documents;
calculating a shared word weight; and
clustering documents with a shared word weight above a specified threshold.

58. The system of claim 47, further comprising means for:
defining a plurality of text units;
calculating a text unit relevancy metric for each text unit based on a comparison of weighted keywords; and
selectively linking text units based on said relevancy metrics.

59. The system of claim 47, further comprising means for creating an adaptable link between text units based on said relevancy metrics.

60. The system of claim 47, further comprising means for updating links when new documents are added to a previously organized corpus of documents.

61. The system of claim 47, further comprising means for clustering and linking documents without user input.
